(19) United States
(12) Patent Application Publication
(10) Pub. No.: US 2014/0096693 A1
(43) Pub. Date: Apr. 10, 2014

(54) APPARATUS OF FORMING PATTERN, METHOD OF MANUFACTURING THE SAME, AND METHOD OF FORMING THE SAME

(71) Applicant: SAMSUNG DISPLAY CO., LTD., Yongin-City (KR)

(72) Inventors: Sang Hoon KIM, Yongin-si (KR); Youngdae KIM, Yongin-si (KR); Moon Won CHANG, Yongin-si (KR)

(21) Appl. No.: 13/778,378

(22) Filed: Feb. 27, 2013

(30) Foreign Application Priority Data
Oct. 10, 2012 (KR) 10-2012-0112532

(51) Int. Cl. B41C 1/08; B41F 9/00

(52) U.S. Cl. CPC B41C 1/08; B41F 9/00
USPC 101/153; 101/170; 216/41

(57) ABSTRACT

A pattern forming apparatus includes a substrate receiving part on which a printed substrate formed with an organic layer thereon is disposed, and a rotation roll that removes portions of the organic layer to form a pattern. The rotation roll includes a rotation body having a cylindrical shape, a pivot engaged with the rotation body to transfer a rotational force to the rotation body, and a blanket attached to an outer surface of the rotation body. The blanket includes an embossed pattern formed on a surface thereof.

### CLAIM OF PRIORITY

This application makes reference to, incorporates the same herein, and claims all benefits accruing under 35 U.S.C. §119 from an application earlier filed in the Korean Intellectual Property Office on the 10 Oct. 2012 and there duly assigned Serial No. 10-2012-0112532.

### BACKGROUND OF THE INVENTION

1. Field of the Invention

The present invention relates to an apparatus for forming a pattern, a method of manufacturing the apparatus, and a method of forming the pattern. More particularly, the present invention relates to an apparatus capable of forming an embossed pattern using an intaglio pattern, a method of manufacturing the apparatus, and a method of forming the embossed pattern.

2. Description of the Related Art

Flat panel display devices, such as an organic light emitting display device, etc., have been widely employed as information display terminals in electronic equipment, e.g., a notebook, a desktop monitor, etc. In particular, the flat panel display devices have advantageous features such as small thickness, light weight, and low power consumption.

Meanwhile, the flat panel display device includes a plurality of organic patterns disposed on a transparent glass or plastic substrate. In general, the organic patterns are formed by a photolithography process. This photolithography process, which is used to form the organic patterns, causes increase in manufacturing cost of the flat panel display device.

### SUMMARY OF THE INVENTION

The present invention provides an apparatus capable of forming a pattern with a simplified process, a method of manufacturing the pattern forming apparatus, and a method of forming the pattern using the pattern forming apparatus.

Embodiments of the invention provide a pattern forming apparatus which includes a substrate receiving part on which a printed substrate formed with an organic layer thereon is disposed, and a rotation roll that removes portions of the organic layer to form a pattern. The rotation roll includes a rotation body having a cylindrical shape, a pivot engaged with the rotation body to transfer a rotational force to the rotation body, and a blanket attached to an outer surface of the rotation body. The blanket comprises an embossed pattern formed on a surface thereof.

The blanket is a glass substrate having a thickness equal to or smaller than 100 micrometers.

A wettability of the blanket with respect to the organic layer is greater than a wettability of the printed substrate with respect to the organic layer.

Embodiments of the invention provide a method of manufacturing a pattern forming apparatus which includes disposing a mask pattern on a blanket substrate, etching the blanket substrate using the mask pattern to form a blanket including an intaglio pattern, attaching the blanket to an outer surface of a rotation body to form a rotation roll, and engaging the rotation roll with the rotation body.

Embodiments of the invention provide a pattern forming method which includes forming an organic layer on a printed substrate, disposing the printed substrate formed with the organic layer thereon on a substrate receiving part of a pattern forming apparatus, and patterning the organic layer using a rotation roll of the pattern forming apparatus to form an embossed pattern on the printed substrate. The embossed pattern is formed in an area corresponding to the intaglio pattern.

The organic layer includes a photosensitive organic material, an insulating organic material, or a conductive organic material.

According to the above, the pattern forming apparatus includes the rotation roll configured to include the blanket formed with the intaglio pattern thereon and the rotation body to which the blanket is attached, and thus the embossed pattern may be formed in an area corresponding to the intaglio pattern by rotating the rotation roll.

Thus, the pattern forming method using the pattern forming apparatus may form the embossed pattern in a shorter time than when the embossed pattern is formed by a photolithography process, thereby reducing a manufacturing cost of the embossed pattern.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view showing a pattern forming apparatus according to an exemplary embodiment of the present invention;

FIGS. 2 to 4 are perspective views showing a method of manufacturing a rotating roll of the pattern forming apparatus shown in FIG. 1; and

FIGS. 5 to 7 are perspective views showing a method of forming a pattern using the pattern forming apparatus shown in FIGS. 1 to 4.

### DETAILED DESCRIPTION OF THE INVENTION

It will be understood that, when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

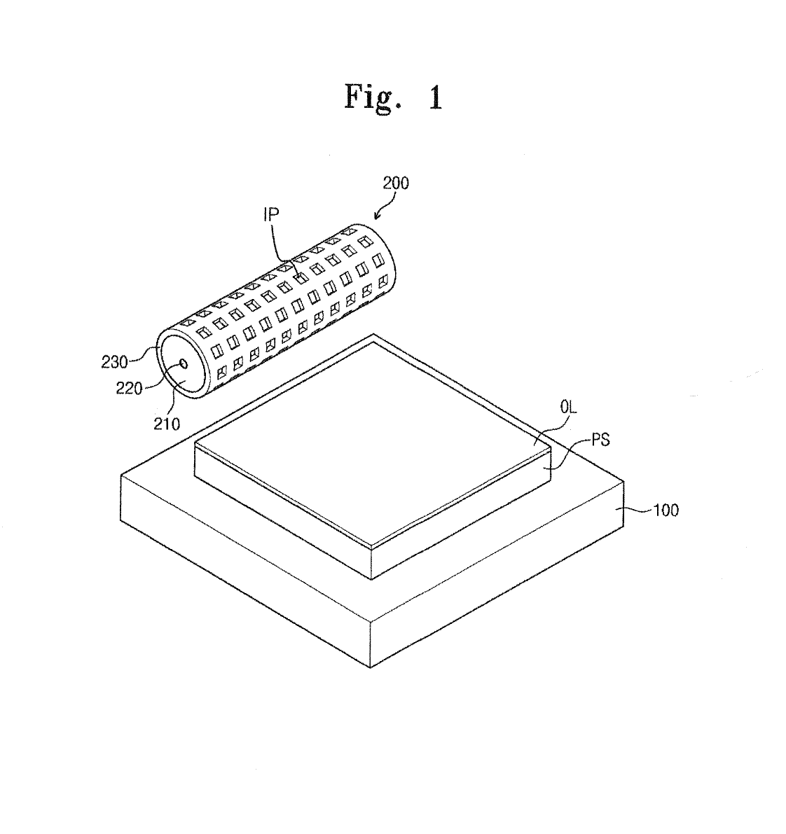

FIG. 1 is a perspective view showing a pattern forming apparatus according to an exemplary embodiment of the present invention.

Referring to FIG. 1, a pattern forming apparatus forms a plurality of patterns, e.g., embossed patterns, on a printed substrate PS. The pattern forming apparatus includes a substrate receiving part 100 on which the printed substrate PS is placed and a rotation roll 200 that forms the embossed patterns on the printed substrate PS.

The substrate receiving part 100 receives the printed substrate PS placed thereon. The substrate receiving part 100 may be, but is not limited to, a stage maintained in a stop state while the embossed patterns are formed on the printed substrate PS. In addition, the substrate receiving part 100 may be a conveyer belt to move the printed substrate PS while the embossed patterns are formed on the printed substrate PS.

The rotation roll 200 removes portions of a material layer OL formed on the printed substrate PS so that only the embossed patterns remain on the printed substrate PS. In addition, the rotation roll 200 includes a rotation body 210 having a cylindrical shape, a pivot 220 engaged with the rotation body 210 so as to transfer a rotational force to the rotation body 210, and a blanket 230 attached to an outer surface of the rotation body 210.

The blanket 230 has flexibility and superior wettability with respect to an organic material. For instance, the wettability of the blanket 230 with respect to the organic material is greater than wettability of the printed substrate PS with respect to the organic material.

In addition, the blanket 230 includes a plurality of intaglio patterns IP formed on a surface thereof. For instance, the blanket 230 may be a thin glass substrate in which the intaglio patterns IP are formed. In the present exemplary embodiment, the glass substrate has a thickness equal to or smaller than about 100 micrometers. When the glass substrate has a thickness equal to or smaller than about 100 micrometers, the glass substrate may have flexibility.

The intaglio patterns IP are used to form the embossed patterns on the printed substrate PS. That is, when the rotation roll 200 is rotated on the printed substrate PS, the portions of the material layer OL, which respectively correspond to the intaglio patterns IP, remain on the printed substrate PS. In addition, portions of the material layer OL, which do not correspond to the intaglio patterns IP, are removed.

The material layer OL includes an organic material, such as a photosensitive organic material, an insulating organic material, or a conductive organic material.

When the material layer OL includes the photosensitive organic material, the embossed patterns may be used as an etch mask to pattern a metal or insulating layer.

When the material layer OL includes the insulating organic material, the embossed patterns may cover specific regions of the printed substrate PS.

When the material layer OL includes the conductive organic material, the embossed patterns may be used as a conductive pattern in a semiconductor device or a display device. For example, the embossed patterns may be a light emitting layer of an organic light emitting display device.

Meanwhile, in the case that the substrate receiving part 100 is a stage in the pattern forming apparatus, the printed substrate PS may be maintained in a stop state. In this case, in order to form the embossed patterns on the printed substrate PS, the pivot 220 is required to move forward while being rotated. Thus, the rotation roll 200 moves forward while being rotated.

In addition, in the case that the substrate receiving part 100 is a conveyer belt in the pattern forming apparatus, the printed substrate PS is maintained in a transfer state. In this case, the pivot 220 performs only a rotary motion but does not perform a progressive motion. Therefore, the rotation roll 200 rotates in place.

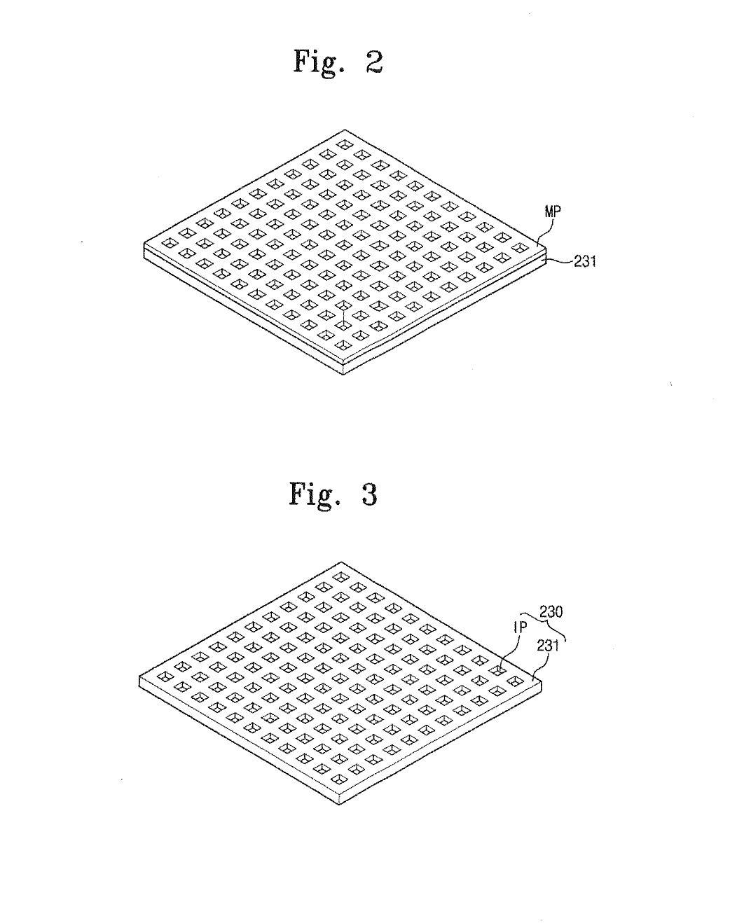

FIGS. 2 to 4 are perspective views showing a method of manufacturing a rotating roll of the pattern forming apparatus shown in FIG. 1.

Referring to FIG. 2, a blanket substrate 231 is prepared. The blanket substrate 231 has flexibility and superior wettability with respect to the organic material. For instance, the blanket substrate 231 may be a glass or plastic substrate. In the present exemplary embodiment, when the blanket substrate 231 is the glass substrate, the blanket substrate 231 has a thickness equal to or smaller than about 100 micrometers so as to have flexibility.

Then, mask patterns MP are formed on the blanket substrate 231. The mask patterns MP are formed by coating a photosensitive organic material on the blanket substrate 231 and exposing/developing the photosensitive organic material using an exposure mask (not shown).

Referring to FIG. 3, the blanket substrate 231 is etched by a wet etch or dry etch method using the mask patterns MP. Due to the etch process, the intaglio patterns IP are formed in the blanket substrate 231 and each intaglio pattern IP has a predetermined depth.

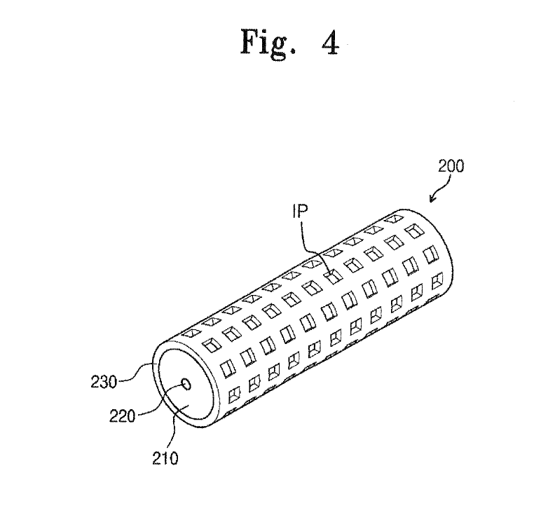

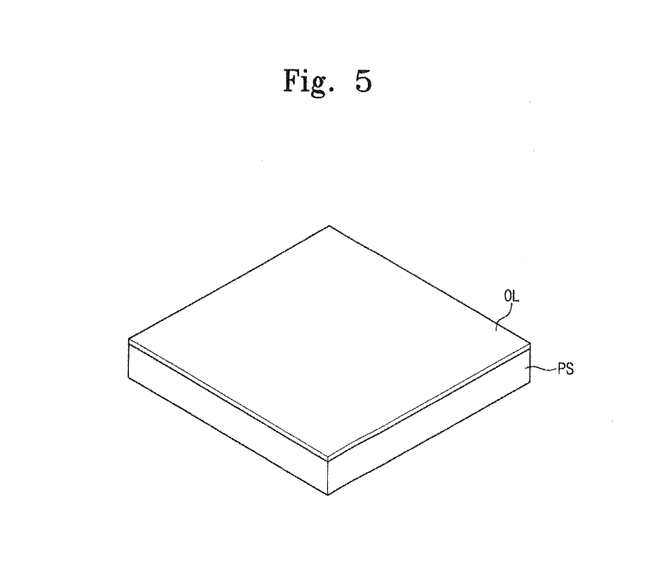

Referring to FIG. 4, the blanket substrate 231 in which the intaglio patterns IP are formed is attached to the outer surface of the rotation body 210 having the cylindrical shape so that the rotation roll 200 is manufactured. Accordingly, the rotation roll 200 may include the intaglio patterns IP on the surface thereof.

Then, the rotation roll 200 is coupled to the pivot 220 so as to manufacture the pattern forming apparatus. Thus, the rotation roll 200 may be rotated by the rotation of the pivot 220.

The pattern forming apparatus may form the embossed patterns on the surface of the printed substrate PS using the rotation roll 200 on which the intaglio patterns IP are formed. In detail, the portions of the material layer disposed on the surface of the printed substrate PS, which do not correspond to the intaglio patterns IP, are removed from the surface of the printed substrate PS by the rotation roll 200. In addition, the portions of the material layer disposed on the surface of the printed substrate PS, which correspond to the intaglio patterns IP, remain on the surface of the printed substrate PS, and thus the embossed patterns are formed on the printed substrate PS.

FIGS. 5 to 7 are perspective views showing a method of forming a pattern using the pattern forming apparatus shown in FIGS. 1 to 4.

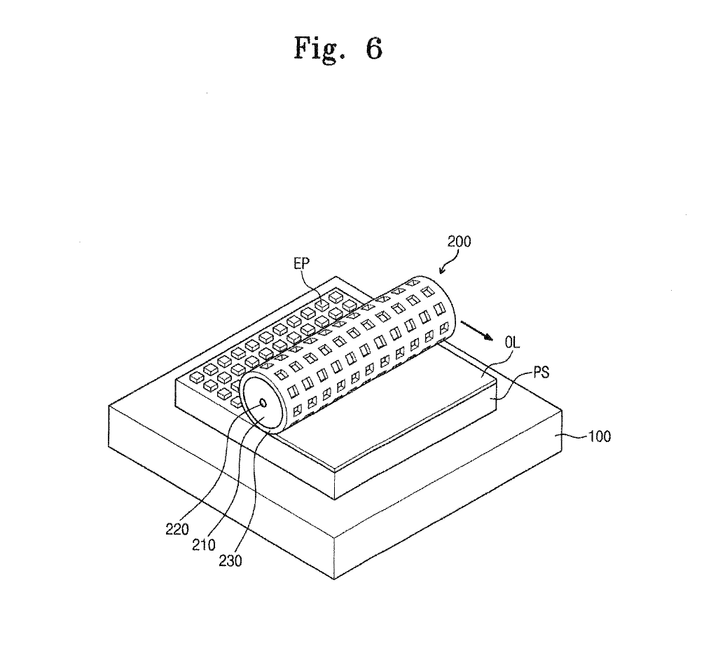

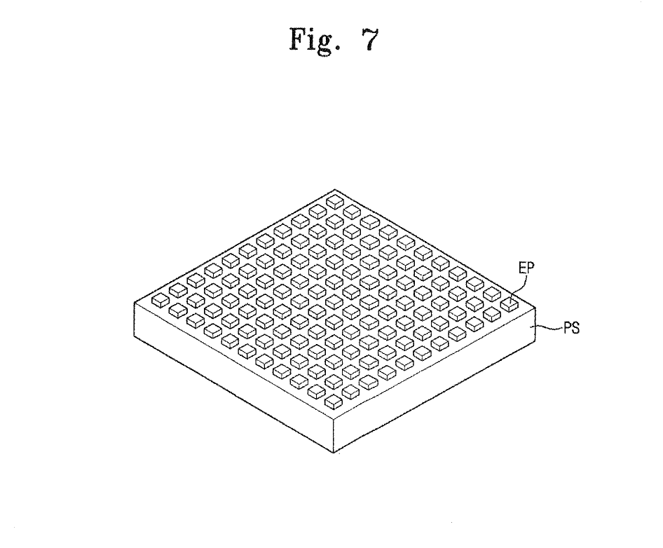

The pattern forming method includes forming an organic layer OL on the printed substrate PS (FIG. 5), disposing the printed substrate PS including the organic layer OL on the substrate receiving part 100 of the pattern forming apparatus (FIG. 6), and patterning the organic layer OL using the rotation roll 200 of the pattern forming apparatus to form the embossed patterns EP on the printed substrate PS (FIGS. 6 and 7).

Referring to FIG. 5, the printed substrate PS is prepared. The printed substrate PS includes a transparent insulating material, so that the printed substrate PS transmits light therethrough. The printed substrate PS may be a rigid type substrate, e.g., a glass substrate, a quartz substrate, a glass ceramic substrate, a crystalline glass substrate, etc., or a flexible type substrate, e.g., a film substrate including a polymer organic material, a plastic substrate, etc. The material included in the printed substrate PS is required to have heat resistance to high temperature generated in the manufacturing process.

In addition, the printed substrate PS may be a thin film transistor substrate. In detail, the printed substrate PS may include a base substrate, a thin film transistor disposed on the base substrate, a protective layer covering the thin film transistor, and a pixel electrode disposed on the protective layer and electrically connected to the thin film transistor.

After that, the organic layer OL is formed on the printed substrate PS. The organic layer OL includes the photosensitive organic material, the insulating organic material, or the conductive organic material.

Referring to FIG. 6, the printed substrate PS, on which the organic layer OL is formed, is disposed on the substrate receiving part 100 of the pattern forming apparatus.

Then, the rotation roll 200 of the pattern forming apparatus is rotated to pattern the organic layer OL. The portions of the organic layer OL, which correspond to the intaglio patterns IP of the rotation roll 200, remain on the printed substrate PS, and the portions of the organic layer OL, which do not correspond to the intaglio patterns IP of the rotation roll 200, are removed from the printed substrate PS. In detail, the portions of the organic layer OL, which do not correspond to the intaglio patterns IP, make contact with portions of the blanket 230, in which the intaglio patterns IP are not formed. In this case, the wettability of the blanket 230 with respect to the organic layer OL is greater than the wettability of the printed substrate PS with respect to the organic layer OL. Accordingly, the portions of the organic layer OL, which do not correspond to the intaglio patterns IP, are attached to the blanket 230 while the rotation roll 200 is rotated, and thus the portions of the organic layer OL, which do not correspond to the intaglio patterns IP, are removed.

In addition, when the substrate receiving part 100 is maintained in the stop state, the rotation roll 200 moves forwardly or backwardly while being rotated so as to pattern the organic layer OL. Furthermore, when the substrate receiving part 100 is maintained in the conveying state, the rotation roll 200 is rotated in place in order to pattern the organic layer OL.

Referring to FIG. 7, when the organic layer OL is patterned by the pattern forming apparatus, the embossed patterns EP are formed on the printed substrate PS. The embossed patterns EP are formed in areas respectively corresponding to the intaglio patterns IP formed in the blanket 230.

Meanwhile, in the case where the organic layer OL includes a photosensitive organic material, the embossed patterns EP patterned by the pattern forming apparatus may be cured by a baking process. The cured embossed patterns EP may be used as the etch mask used to pattern the metal or insulating layer.

In addition, in the case where the organic layer OL includes an insulating organic material, the embossed patterns EP patterned by the pattern forming apparatus may cover specific areas of the printed substrate PS.

Furthermore, in the case where the organic layer OL includes a conductive organic material, the embossed patterns EP patterned by the pattern forming apparatus may be used as the conductive patterns of the semiconductor device or the display device. For instance, the embossed patterns EP may be the light emitting layer of the organic light emitting display device.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A pattern forming apparatus, comprising:
a substrate receiving part on which a printed substrate, formed with an organic layer thereon, is disposed; and
a rotation roll for removing portions of the organic layer to form a pattern;
the rotation roll comprising:
a rotation body having a cylindrical shape;
a pivot engaged with the rotation body to transfer a rotational force to the rotation body; and
a blanket attached to an outer surface of the rotation body, the blanket comprising an embossed pattern formed on a surface thereof.

2. The pattern forming apparatus of claim 1, the blanket being a glass substrate having a thickness not greater than 100 micrometers.

3. The pattern forming apparatus of claim 1, a wettability of the blanket with respect to the organic layer being greater than a wettability of the printed substrate with respect to the organic layer.

4. A method of manufacturing a pattern forming apparatus, comprising the steps of:
disposing a mask pattern on a blanket substrate;
etching the blanket substrate using the mask pattern to form a blanket including an intaglio pattern;
attaching the blanket to an outer surface of a rotation body to form a rotation roll; and
engaging the rotation roll with the rotation body.

5. The method of claim 4, the blanket substrate being a glass substrate having a thickness not greater than 100 micrometers.

6. The method of claim 4, the blanket substrate having a wettability with respect to an organic material.

7. A pattern forming method, comprising the steps of:
forming an organic layer on a printed substrate;
disposing the printed substrate, formed with the organic layer thereon, on a substrate receiving part of a pattern forming apparatus; and
patterning the organic layer using a rotation roll of the pattern forming apparatus to form an embossed pattern on the printed substrate;
the rotation roll comprising:
a rotation body having a cylindrical shape;
a pivot engaged with the rotation body to transfer a rotational force to the rotation body; and
a blanket attached to an outer surface of the rotation body and including an intaglio pattern formed on a surface thereof, the embossed pattern being formed in an area corresponding to the intaglio pattern.

8. The method of claim 7, the organic layer comprising one of a photosensitive organic material, an insulating organic material, and a conductive organic material.

9. The method of claim 7, the blanket being a glass substrate having a thickness not greater than 100 micrometers.

10. The method of claim 7, a wettability of the blanket with respect to the organic layer being greater than a wettability of the printed substrate with respect to the organic layer.
